(19) United States
(12) Patent Application Publication
(10) Pub. No.: US 2020/0311897 A1
(43) Pub. Date: Oct. 1, 2020

(54) METHOD FOR SHEET INSPECTION INCLUDING BRIGHTNESS ADAPTATION

(71) Applicant: HEIDELBERGER DRUCKMASCHINEN AG, Heidelberg (DE)

(72) Inventor: FRANK SCHUMANN, HEIDELBERG (DE)

(21) Appl. No.: 16/825,649

(22) Filed: Mar. 20, 2020

(30) Foreign Application Priority Data
Apr. 1, 2019 (DE) 102019204551

(51) Int. Cl. G06T 7/00; G06T 7/90; G06T 7/11

(52) U.S. Cl. CPC G06T 7/001; G06T 2207/30144; G06T 7/11; G06T 7/90

(57) ABSTRACT

A method for inspecting images on printed products of a printing substrate processing machine includes using at least one image sensor of an image recording system, in the course of the image inspection process, to record and digitize the printed products that have been produced. The computer compares the recorded digital printed images that have been created in this way to a digital reference image. In the case of deviations between the recorded digital printed images and the digital reference image, the printed products that have been found defective are removed. The computer divides the digital print images and the reference images into respective image parts and compensates for brightness differences between the image parts.

### CROSS-REFERENCE TO RELATED APPLICATION

This application claims the priority, under 35 U.S.C. § 119, of German Patent Application DE 10 2019 204 551, filed Apr. 1, 2019; the prior application is herewith incorporated by reference in its entirety.

### BACKGROUND OF THE INVENTION

### Field of the Invention

The present invention relates to a method for inspecting images on printed products in a printing machine.

The technical field of the invention is the field of quality control.

In today's printing industry, in particular in larger printing machines, quality control is carried out in an automated way by so-called in-line inspection systems, which will be referred to as image recording systems herein. In that context, in-line means that the image recording system, or, to be more precise, the camera of the image recording system, is disposed in the printing machine. In general, it is disposed downstream of the last printing unit or downstream of a further processing unit such as a varnishing unit, if such a unit is provided, to record the printed products created in the printing machine. There may be just one camera or a camera system including multiple cameras. The use of other image sensors is likewise possible. However, for reasons of simplicity, only the term “camera” will be used in the present document. Illumination usually occurs at a defined angle relative to the axis of the camera. An image processor then compares the digitized printed images the camera has created in that way to corresponding good images of the image to be printed. Those good images may be created on the basis of pre-print data or they may be taught in. In that case, teaching-in or training means that a number of printed products bearing the image to be printed are printed and recorded by the camera of the image recording system. Those sample prints ought to be as defect-free as possible. Once they have been recorded by the image recording system, they are saved on the image processor as digital reference images.

During the production run, the camera of the image recording system records the created printed image or parts thereof for them to be compared to the reference image that has been created on the basis of pre-print data or digitally taught in. If that process finds deviations between the printed products created in the production run and the digital reference, the operator is alerted to the deviations and may then decide whether the deviations are acceptable or whether the printed products that have been created in that way are waste and need to be removed. The printed sheets that have been found to be waste may be removed by a waste removal switch. In that context an aspect of major importance is to ensure that on one hand, the reference image is without defects and that on the other hand, the actual print that has been recorded by the image recording system corresponds to the actual image that has been printed. Defects that are created as a result of the recording process, for instance due to insufficient illumination, a contaminated lens of the camera, or other influences, must not have any negative effect on the inspection process.

A very specific problem that actually has a negative effect on the inspection process in that respect is that irregularities may occur when the printing substrate is transported within the printing machine. In order to ensure high-quality image recordings, the transported printing substrate needs to be transported past the camera of the image recording system as smoothly and free of disturbances as possible. That is a great challenge especially for sheet-fed printing machines. A known problem in that context is that the trailing edge of a printing sheet that is being transported starts to vibrate as it is transported over the sheet-guiding plate and it may flip upward and start to “flutter.” Although that is not a problem for recording images located in the leading and central regions on the sheet, the fluttering effect has a negative influence on printed images located at the trailing end of the printed sheet. That is because if the sheet is not wrapped around the printing cylinder in an ideal way the illumination system, which is dependent on the mechanical layout, may no longer illuminate the sheet in an optimum way, resulting in a loss of brightness at the relevant locations. In short, a fluttering trailing edge of the sheet will cause that region of the image to be recorded as being darker than the remaining parts of the image. That effect will always be present in the recorded print but will only be present in the reference image if the latter has been taught in. If the reference image was created from digital pre-print data, the effect does not occur, causing the differences in brightness between the recorded print and the reference image to be much more pronounced than in the case of a taught-in reference image.

That problem may be solved by ideally illuminating the image exactly from the direction of the camera. A possible configuration to do so would be annular illumination about a camera. For mechanical reasons, however, such an illumination configuration is impossible in many printing machines.

A further prior art approach to solving the illumination problem is to reduce the quality of the inspection at the trailing edge of the sheet. In that process, the quality of the inspection at the trailing edge of the sheet is reduced irrespective of the illumination to avoid pseudo-defects caused by the difference in brightness. That approach has corresponding disadvantages.

The two main disadvantages are:

1. If the quality of the inspection at the trailing edge is not reduced, pseudo defects will occur more often than in other image areas. However, in general, pseudo-defects are a nuisance to the operator.
2. If the quality of the inspection at the trailing edge is reduced, actual defects in the print may not be identified.

This is a catch-22 situation: full-quality inspection results in pseudo defects caused by insufficient illumination of the trailing edge of the sheet. However, when the bad illumination in those areas during the image inspection process is compensated for by reducing the quality of the inspection, genuine defects in the print that the image inspection ought to detect risk being overlooked.

German Patent Application DE 10 2016 224 307 A1, corresponding to U.S. Pat. No. 9,953,435, discloses a method for checking an image inspection system formed of a camera system with at least one camera, an illumination device for a targeted illumination of the printing substrate, an image processor and a main processor for controlling the quality of products created in a machine for processing printing substrates by using the main processor. The method analyzes unprinted areas in digital prints on printing substrates recorded by the camera system to draw conclusions on the condition of the image inspection system, including the condition of the illumination device. However, the method does not include an actual inspection of the image, which means that the method does not provide any instructions on how to correct errors, for instance caused by insufficient illumination in an ongoing image inspection process.

In addition, to solve the problem of the fluttering trailing edge of a sheet, German Patent Application DE 10 2018 220 236 A1, corresponding to U.S. patent application Ser. No. 16/696,224, filed Nov. 26, 2019, describes a method for inspecting images on printed products in a machine for processing printing materials by using a computer, the method including the steps of recording and digitizing produced printed products by using at least one image sensor in the course of the image inspection process carried out by using an image recording system, comparing the recorded digital printed images that have been created in this way to a digital reference image by using the computer, previously digitally eliminating distortions in the recorded digital prints by using the computer, and, if deviations are detected between the recorded digital distortion-free prints and the digital reference, removing the defective printed products. The method is distinguished in that digitally to eliminate distortions, the computer subdivides the printed images and the reference images into respective image parts and adapts the positions of the printed image parts in a pixel-by-pixel way to minimize the difference between the print image parts and the respective reference image part. However, that method deals with the optical distortions that occur in the image recorded by the camera due to the unstable trailing edge of the sheet and the resultant problems. However, German Patent Application DE 10 2018 220 236 A1, corresponding to U.S. patent application Ser. No. 16/696,224, filed Nov. 26, 2019, does not deal with the specific problems caused by insufficient illumination nor with a solution thereto.

### BRIEF SUMMARY OF THE INVENTION

It is accordingly an object of the invention to provide an improved method for inspecting images on printed products, which overcomes the hereinafore-mentioned disadvantages of the heretofore-known methods of this general type and which overcomes the negative effects of insufficient illumination.

With the foregoing and other objects in view there is provided, in accordance with the invention, a method for inspecting images on printed products by using a computer, in which the printed products are created by a machine for processing printing substrates, wherein in the course of the image inspection process, at least one image sensor of an image recording system records and digitizes the printed products that have been produced, the computer compares the recorded digital printed images that have been created in this way to a digital reference image, in the case of deviations between the recorded digital printed images and the digital reference image, the printed products that have been found defective are removed, and the computer divides the digital print images and the reference images into respective image parts and compensates for brightness differences between the image parts.

Since the effects of the insufficient illumination only occur in specific areas of the recorded digital printed images, in a way those areas need to be separated from the unaffected areas. In accordance with the invention, this is achieved by subdividing the recorded digital printed images into image parts. Since the image inspection process is based on a comparison between a recorded printed image and a reference image, the reference images need to be subdivided into such image parts in a corresponding way. If any brightness differences occur between an image part of the printed image and the corresponding image part of the reference image, namely differences that are clearly caused by insufficient illumination and may thus only occur in the digitally recorded printed image and not in the reference image, the computer modifies the relevant image parts in the printed and reference images in such a way that the brightness differences are compensated for. This ensures that the image inspection based on a comparison between the printed image and the reference image will not detect any pseudo defects caused by insufficient illumination. The compensation for brightness differences in accordance with the invention is carried out before the step of comparing in the image inspection process so that the corresponding “pre-treatment” of the digital printed and reference images occurs before the actual image inspection process in that the treated image parts are recombined to form the actual digital printed and reference images before the image inspection process. However, it is likewise possible for the comparison to be made between the image parts of the printed image and of the reference image in the image inspection process and to combine brightness compensation in accordance with the invention and image inspection in a single step.

Advantageous and thus preferred further developments of the method will become apparent from the associated dependent claims and from the description together with the associated drawings.

Another preferred development of the method of the invention in this context is that the computer implements the compensation for brightness differences between the image parts by using a correction value that is subtracted from the respective brighter one of printed image and reference image. In order to provide compensation for the brightness differences, the computer first needs to quantify the brightness differences. Once this has been done, the computer may calculate the correction value that quantifies the brightness difference and is then subtracted from the respective brighter one of the printed image and the reference image. This means that the respective brighter one of printed image part and reference image part is darkened. In principle, it would be possible to brighten the respective darker image, but in most cases a comparison between darker images is less prone to errors than a comparison between artificially brightened images.

A further preferred development of the method of the invention in this context is that the computer calculates the correction value by determining an average brightness value of the image parts, comparing the average brightness values of a digital printed image part and a reference image part, and calculating the correction value by subtracting the two average brightness values from one another if a deviation occurs. As mentioned above, the correction value represents the brightness difference between the image part of the recorded digital printed image and the digital reference image. The easiest way to calculate the correction value is to determine the average brightness value of both image parts and to compare them to one another. The correction value is then obtained by subtracting the two medium brightness values of both image parts from one another. Since in addition, even with adequate illumination, the average brightness value of the recorded digital printed image will virtually never be completely identical with the brightness value of the ideal digital reference image, a tolerance threshold is recommended. It is only if this tolerance is exceeded that a deviation between the two average brightness values will be detected. This is because if these two average brightness values only slightly deviate, for instance in the aforementioned case of an illumination system that is functioning properly, no correction of the corresponding image parts in accordance with the invention is required.

An added preferred development of the method of the invention in this context is that when the two average brightness values are subtracted, the computer always subtracts the average brightness value of the recorded digital printed image from the average brightness value of the digital reference image and, if the result is numerically negative, the calculated correction value is subtracted from the recorded digital printed image and, if the result is numerically positive, the calculated reference value is subtracted from the digital reference image. Since, as mentioned above, the aim is to darken the respective brighter one of the image parts, the first step needs to be to identify the respective brighter one of the image parts. This is done by subtracting the average brightness value of the recorded digital printed image from the average brightness value of the ideal digital reference image. If the result is numerically negative, it is clearly the recorded digital printed image that is the brighter one, since a higher brightness value results in a numerically higher average brightness value. In such a case, the calculated correction value needs to be subtracted from the recorded digital printed image. However, if in contrast the result is numerically positive, the digital reference image is the brighter one that needs to be darkened by the correction value.

An additional preferred development of the method of the invention in this context is that the computer separates the respective image parts into color separations and determines the average brightness value of the respective color separations. Although the calculation of the average brightness values of the corresponding image parts may be calculated on the basis of the respective normal images that are available in digital form, the method of the invention is much more accurate if the image parts are divided into color separations and if the respective average brightness value is determined for all color separations. Accordingly, in most cases, the correction value for all color separations is calculated and applied in an R, G, B format because in most cases the available digital images are camera images in an RGB color space. Once the brightness difference compensation in accordance with the invention has been completed, the color separations are recombined and the reassembled image is inspected. Alternatively, image inspection may of course be carried out by using the individual color separations. In this case, the digital reference clearly likewise needs to be divided into color separations and, in addition, needs to be available in the same color space as the recorded digital reference image.

Another preferred development of the method of the invention in this context is that the machine for processing printing substrates is a sheet-fed printing machine and the printing substrates are printing sheets. The problem of insufficient illumination mainly occurs on printing sheets in a sheet-fed printing machine because as indicated above the fluttering of the trailing edge of the sheet during transport makes the illumination process more difficult. Nevertheless, the method of the invention may also be used in other types of printing machines and for other types of printing substrates whenever there are problems with insufficient illumination.

An added preferred development of the method of the invention in this context is that the computer only subdivides the images into image parts in printed image and reference image areas that are within the area of influence of the trailing edge of the sheet. As explained above, when a sheet-fed printing machine is used, the relevant areas suffering from insufficient illumination are mostly located at the trailing edge of the sheet. Therefore, the subdivision into image parts in accordance with the invention only needs to occur in the area of influence of the trailing edge of the sheet needs. Although applying the method of the invention to the entire area of the printed and reference images does no harm, because in these areas no correction value will be calculated and applied if expedient thresholds are in place, it is unnecessary and thus reduces the performance of the method of the invention.

An additional preferred development of the method of the invention in this context is that the image parts of the printed image and the image parts of the reference image are of identical size. In order for the method of the invention to work properly, a printed image part and a corresponding reference image part that form an image part pair need to be of identical size. This means that an image part of the recorded digital printed image that is compared to an image part of the digital reference image needs to be of the same size as its corresponding counterpart in the reference image because otherwise the average brightness values would deviate due to differences in image content rather than due to insufficient illumination, causing the method of the invention to yield incorrect results. However, in addition, the individual image parts within the recorded digital printed image ought to be of identical size as well as the individual image parts of the corresponding reference image to simplify the subdivision process. However, in contrast to the identical size requirement for the image part pairs of printed image and reference image, this latter aspect is not an absolute necessity. It is quite possible for the printed and reference images to be subdivided into parts of different sizes as long as the image part pairs formed of the image part of the printed image and the corresponding image part of the reference image are of identical size.

Another preferred development of the method of the invention in this context is that the image parts are shaped like thin horizontal stripes, since narrow horizontal tiles yield better results for the trailing edge than square tiles.

A concomitant preferred development of the method of the invention in this context is that the image parts are polygonal in shape, in particular rectangular, square, or triangular. The image parts may have various shapes. Polygonal shapes, in particular rectangular shapes, have been found to be practical. However, other shapes, for instance rectangles of different shapes or triangles, are likewise possible, because triangular tiles are better suited for approximating curved surfaces in a three-dimensional space than rectangular ones. However, they are more difficult to process in programming terms. Moreover, since the entire digital print image is to be divided, circular shapes are less suitable.

Other features which are considered as characteristic for the invention are set forth in the appended claims. The invention as such as well as further developments of the invention that are advantageous in structural and/or functional terms will be described in more detail below with reference to the associated drawings and based on at least one preferred exemplary embodiment.

Although the invention is illustrated and described herein as embodied in a method for sheet inspection including brightness adaptation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of an example of an image recording system in a sheet-fed lithographic offset printing machine;

FIG. 2 is a diagrammatic, side-elevational view illustrating a properly functioning image recording process with illumination;

FIG. 3 is a side-elevational view illustrating an image recording process with unsatisfactory illumination at the trailing edge of the sheet;

FIG. 4 is a plan view of a sheet illustrating an example of an image section (image part) of an ideal reference image;

FIG. 5 is a plan view of a sheet illustrating an example of an image section (image part) of a recorded printed image including a darker area at the trailing edge of the sheet and an image defect;

FIG. 6 is a plan view of a sheet illustrating an example of a differential image between the recorded printed image and reference image as a result of an image inspection process for the image section (image part);

FIG. 7 is a plan view of a sheet illustrating an example of a brightness-compensated image section (image part) of the ideal reference image;

FIG. 8 is a plan view of a sheet illustrating an example of a brightness-compensated image section (image part) of the recorded printed image;

FIG. 9 is a plan view of a sheet illustrating an example of a differential image as a result of the image inspection process based on the brightness-compensated image sections (image parts); and

FIG. 10 is a flow chart of the method of the invention.

### DETAILED DESCRIPTION OF THE INVENTION

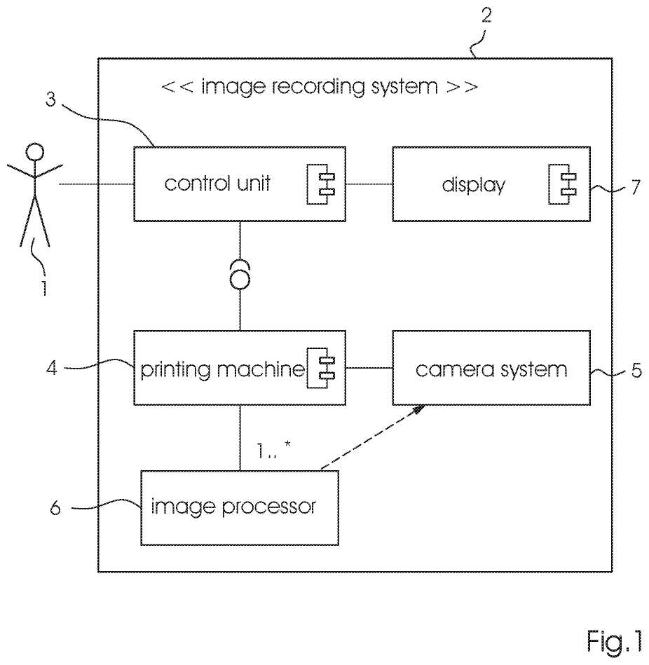

Referring now in detail to the figures of the drawings, in which mutually corresponding elements have the same reference symbols, and first, particularly, to FIG. 1 thereof, there is seen an example of an image recording system 2 implementing the method of the invention. The system is formed of at least one image sensor 5, usually a camera 5, which is integrated into the sheet-fed printing machine 4. The at least one camera 5 records the printed images generated by the printing machine 4 and transmits the data to a computer 3, 6 for analysis. This computer 3, 6 may be a separate computer 6, e.g. one or more dedicated image processors 6, or it may be identical with the control unit 3 of the printing machine 4. At least the control unit 3 of the printing machine 4 has a display 7 for displaying the results of the image inspection process to an operator 1.

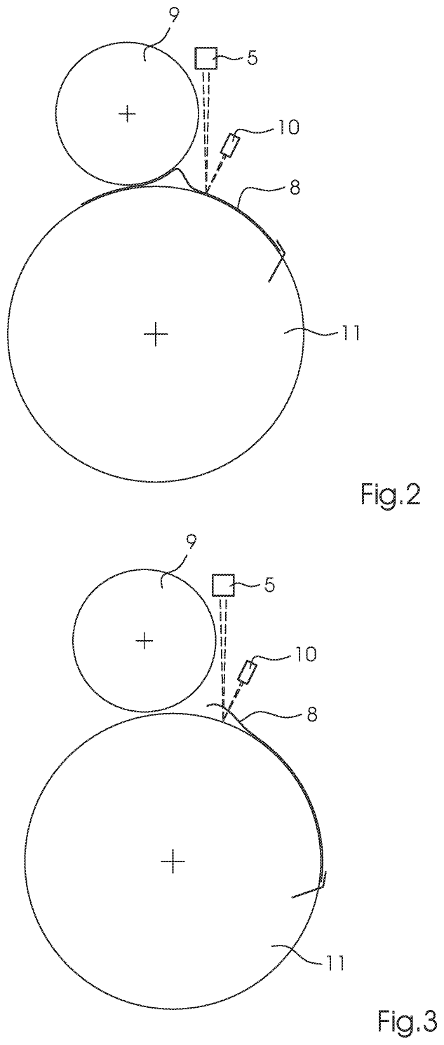

FIG. 2 illustrates a mechanical configuration of a sheet inspection system and the physics for a case in which a printing sheet 8 has not left a printing nip between a blanket cylinder 9 and an impression cylinder 11. In this case, an inspection point of the camera 5 and an illumination point of an illumination unit 10 coincide and the image inspection process may proceed at optimum illumination. FIG. 3 illustrates a case in which image inspection takes place at the trailing edge of the sheet as mentioned above. This drawing likewise shows the mechanical configuration of a sheet inspection system and the physics of a case in which the printing sheet 8 has left the printing nip and flutters. It is clearly shown that in this case, the point of inspection of the camera 5 and the illumination point do not coincide and therefore the illumination is not ideal for sheet inspection purposes. This causes a recorded printing image 13 to become darker and has a corresponding effect on the image inspection process.

The invention remedies this situation, providing high-quality inspection even at the trailing edge of the sheet without any higher costs and without creating pseudo defects 15, 15a. The fundamental principle is a local adaptation of the brightness values in the recorded camera images 13.

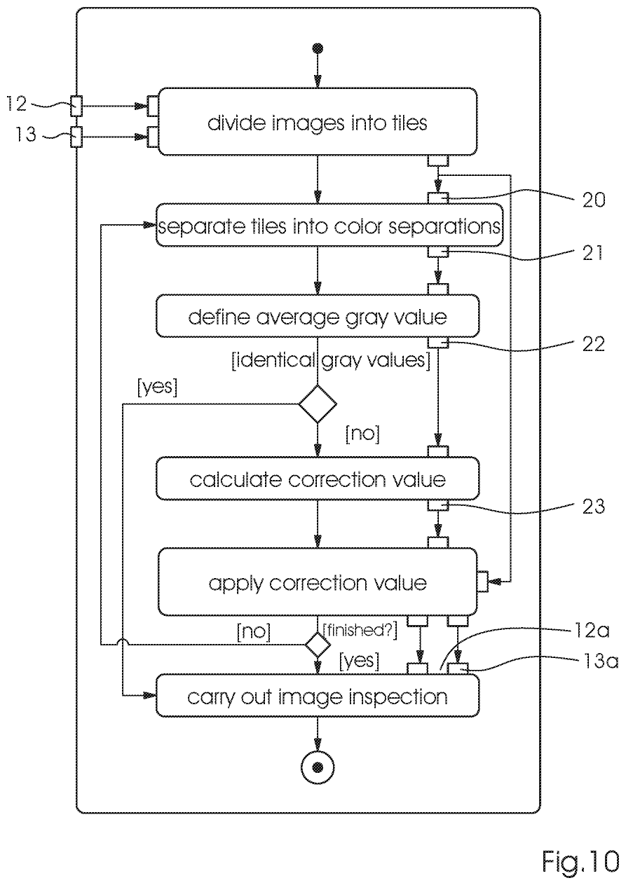

FIG. 10 is a schematic flow chart of a preferred embodiment of the method of the invention. The first step is to create a reference image 12. Whether this is done on the basis of preprint data or by teaching in is irrelevant to the method of the invention. Then printed products 8 in the form of printed sheets 8 that have been produced are recorded and digitized by using the image recording system 2, i.e. the camera system 5 thereof, in the course of the image inspection process. This is where the method of the invention starts. The image processor 6 divides recorded prints 13 and the reference image 12 for comparison into image parts 20.

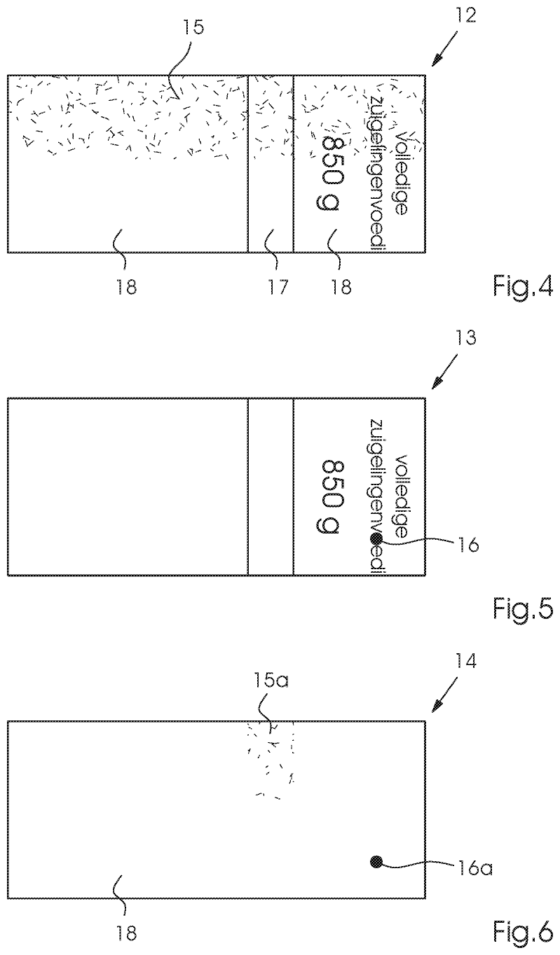

FIG. 4 illustrates an image section at the trailing edge of the reference image 12. In this case, the reference image has been taught-in as a good image 12. The figure clearly shows dark image areas 15 in the upper image area caused by the fluttering of the trailing edge of the sheet in the reference image 12 as well.

FIG. 5 illustrates the same image section at the trailing edge of the sheet on the recorded digital print 13. In this case, the print sheet 8 does not flutter as much as in the reference image 12 and consequently the trailing edge image areas are brighter. The blackened “o” in the lower right-hand fifth of the image is a genuine print defect 16 that needs to be detected in the image inspection process.

FIG. 6 illustrates the same image section of a differential image 14 between the reference image 12 and the printed image 13 as it is created in the course of the image inspection process. Large differences between the two images 12, 13 are shown. The marked image areas 15a in the upper image half are undesired pseudo defects 15a. The marked black “o” in the lower right-hand fifth of the image represents a genuine print defect 16a that has been detected. The marked deviations 15a shown in FIG. 6 in the upper image half are exclusively caused by sub-optimal illumination due to a fluttering of the trailing edge of the sheet and therefore constitute undesired pseudo defects 15a. Since the marked deviations 15a in the form of the darker areas 15 (see FIG. 4) are more pronounced on a bright image background 17 than on a darker image background 18, they are only marked as pseudo defects 15a on the bright image background 17 in the differential image 14.

The solution to this problem is the core of the method of the invention. Since the fluttering behavior at the trailing edge of the printing sheet 8 is complex and variable, it is impossible to correct brightness values 22 using fixed values. Therefore, correction values 23 are derived from the taught-in reference image 12 as follows:

As mentioned above, the image processor 6 divides the reference image (good image) 12 and the recorded digital image 13 on the current print sheet 8 into image parts 20. Then the image processor 6 separates every digital image part 20 into its three color separations RGB 21. Since the reference image 12 has been taught in on the basis of recorded digital print images 13, it is likewise available in an RGB format, allowing it to be divided into the color separations 21. If, in an alternative embodiment, the reference image 12 is created on the basis of digital preprint data, it either needs to be available in an RGB format from the start or a color transformation into this format needs to be made. Then the image processor determines an average gray value 22 for every one of the color separations 21 of an image part 20 of the reference image 12 and of the printed image 13. If the values are not the same, the image processor corrects the gray values 22 in the color separation 21 in question of the image part 20. A correction value D 23 is calculated as follows:

N=(average gray value in the reference image)
O=(average gray value in the printed image) and D=N−O.

If D>0, D is subtracted from every gray value 22 of every pixel within the reference image part to darken the reference image 12 in a corresponding way. If D<0, D is subtracted from every gray value 22 of every pixel within the printed image part to darken the printed image 13 in a corresponding way.

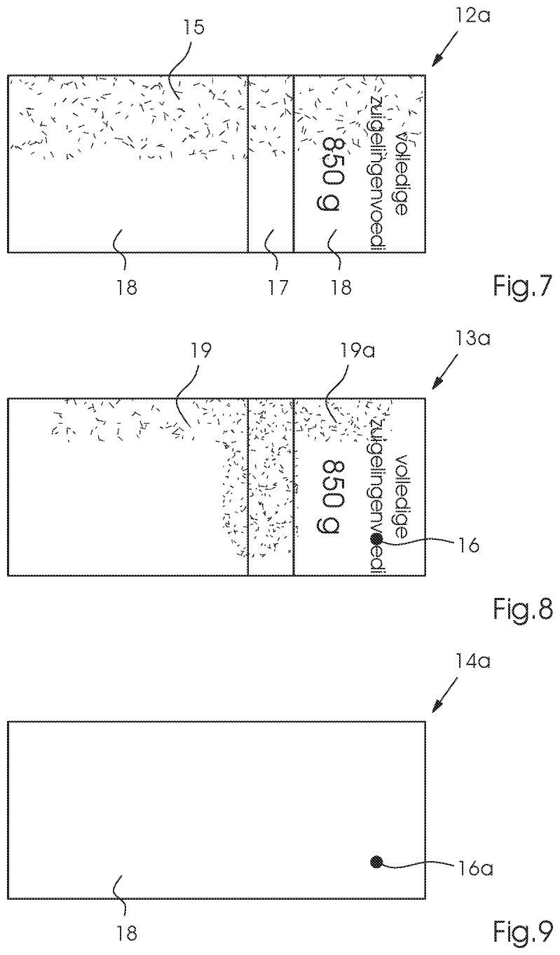

If the method of the invention is applied to the original images 12, 13 in accordance with FIGS. 4 and 5, images 12a, 13a that have been corrected in terms of brightness are obtained as shown by way of example in FIGS. 7 and 8. In this example, brightness correction has only been made in the recorded printing 13a in FIG. 8. FIG. 7 again shows the corresponding image section at the trailing edge of the sheet on the reference image 12. FIG. 8 illustrates the same image section of the corrected recorded digital print image 13a at the trailing edge of the sheet. The drawing clearly shows regions 19, 19a formed by individual corrected image parts 20 in which brightness correction in accordance with the invention has been made. The left-hand area 19 was darkened to a lesser extent than the right-hand area 19a. A comparison between these corrected images 12a, 13a in the form of a corrected differential image 14a in FIG. 9 shows that the pseudo defects 15a disappear. FIG. 9 thus shows the same image section of the differential image 14a between the corrected reference image 12a and the print image 13a. One can see that there are no longer any marked pseudo defects 15a in the upper image half—in contrast to the uncorrected differential image 14 shown in FIG. 6. The marked black “o” in the lower right-hand image fifth is the actual print defect 16a that needs to be detected and remains visible as desired.

Once all color separations 21 have been corrected, they are recombined to form a complete RGB image part 20, which is then inserted into reference image 12a/printed image 13a at the original position. In this way, a localized adaptation of the brightness values is achieved for every image part 20. These processed images 12a, 13a are then used in the actual image inspection process.

Moreover, in lithographic offset printing, it has been found advantageous to select thin horizontal stripes as a geometrical shape for the image parts 20. A reason for this is that in this printing technique, the brightness fluctuation rate is high in the printing direction yet low in a direction transverse to the printing direction. Narrow horizontal image parts at the trailing edge yield better results than square image parts. However, it is possible to vary the shape of the image parts 20 as a function of the actual application. In general, square or triangular image parts are most suitable. Curved surfaces in a 3-dimensional space may more easily be approximated by triangular image parts than by square image parts, although the former are more difficult to process in programming terms.

### LIST OF REFERENCE SYMBOLS

1 operator
2 image recording system
3 control unit
4 printing machine
5 image sensor
6 image processor
7 display
8 print sheet
9 blanket cylinder
10 illumination unit
11 impression cylinder
12 good image/reference image
12a good image/reference image after brightness correction
13 recorded print image
13a recorded print image after brightness correction
14 differential image with brightness deviation
14a differential image after brightness correction
15 dark image areas
15a recorded dark image areas (pseudo defects) in the differential image
16 genuine print defect
16a detected print defect in the differential image
17 bright image background
18 dark image background
19, 19a image areas after brightness correction
20 image parts
21 color separations of image parts
22 average gray value/brightness value
23 correction value

1. A method for inspecting images on printed products of a printing substrate processing machine, the method comprising the following steps:
using at least one image sensor of an image recording system, during an image inspection process, to record and digitize printed products having been produced;
using a computer to compare recorded digital printed images created during the image inspection process to a digital reference image;
removing defective printed products when deviations occur between the recorded digital printed images and the digital reference image; and
using the computer to divide the digital printed images and the reference images into respective image parts and to compensate for brightness differences between the image parts.

2. The method according to claim 1, which further comprises using the computer to employ a correction value subtracted from a respective brighter one of the printed image and the reference image to compensate for the brightness differences between the image parts.

3. The method according to claim 2, which further comprises using the computer to calculate the correction value by:
determining an average brightness value for the image parts;
comparing the average brightness values of a respective image part of the digital printed image and the reference image; and
calculating the correction value by subtracting the two average brightness values from one another when a deviating occurs.

4. The method according to claim 3, which further comprises subtracting the two average brightness values from one another by:
using the computer to always subtract the average brightness value of the recorded digital printed image from the average brightness value of the digital reference image;
when a result of the subtraction is numerically negative, using the computer to subtract the calculated correction value from the recorded digital printed image; and
when a result of the subtraction is numerically positive, using the computer to subtract the calculated correction value from the digital reference image.

5. The method according to claim 3, which further comprises using the computer to separate the respective image parts into color separations thereof and to establish the average brightness value for the respective color separations.

6. The method according to claim 4, which further comprises using the computer to separate the respective image parts into color separations thereof and to establish the average brightness value for the respective color separations.

7. The method according to claim 1, which further comprises providing a sheet-fed printing machine as the printing substrate processing machine, and providing printing sheets as the printing substrates.

8. The method according to claim 7, which further comprises using the computer to divide the printed images and reference images into image parts only in regions within a range of influence of a trailing edge of a sheet.

9. The method according to claim 1, which further comprises providing the image parts of printed images and reference images with identical sizes.

10. The method according to claim 1, which further comprises providing the image parts with a horizontal stripe shape.

11. The method according to claim 1, which further comprises providing the image parts with a polygonal shape.

12. The method according to claim 11, which further comprises selecting the polygonal shape as a rectangular, a square or a triangular.
